(19) United States
(12) Patent Application Publication
(10) Pub. No.: US 2015/0179081 A1
(43) Pub. Date: Jun. 25, 2015

(54) SYSTEM AND METHOD FOR ADMINISTERING TESTS

(71) Applicant: Waterloo Maple Inc., Waterloo (CA)

(72) Inventors: Laurent Bernardin, Kitchener (CA); Paul Demarco, New Dundee (CA); William John Calvin Huiskamp, Guelph (CA)

(73) Assignee: Waterloo Maple Inc., Waterloo (CA)

(21) Appl. No.: 14/137,297

(22) Filed: Dec. 20, 2013

(51) Int. Cl. G09B 7/00

(52) U.S. Cl. CPC G09B 7/00

(57) ABSTRACT

A system and method for providing a test online is provided. The test may include questions that can be automatically graded by a test server. The test may include questions that incorporate math applications that do not include functionality for grading the math application.

### TECHNICAL FIELD

The current disclosure relates to a system and method for administering tests, and in particular to a system and method of administering and grading tests incorporating one or more existing interactive math applications.

### BACKGROUND

Computer systems have been developed for use in teaching information. The systems may include interactive applications designed to allow a user to interact with components that present a concept or problem. For example an interactive application may be designed to allow a user to adjust values of an equation and view the results. These interactive applications may be shared and used by numerous teachers as well as students.

Additional systems provide electronic test setting and proctoring functionality. A teacher may define a test comprising a number of questions, which may be provided to a user for taking. The user provides their answers to the questions, which are stored electronically. The testing systems may provide grading functionality for automatically grading a user's answer and/or may allow manual grading of answers by a teacher.

Although various systems exist for teaching and testing of information, it is desirable to be able to generate tests incorporating pre-existing interactive elements used to present a concept or problem.

### BRIEF DESCRIPTION OF THE DRAWINGS

These and other features, aspects and advantages of the present disclosure will become better understood with regard to the following description and accompanying drawings wherein:

FIG. 1 depicts a math application display;

FIG. 2 depicts a display of a test question incorporating the math application of FIG. 1;

FIG. 3 depicts a teaching and assessment environment;

FIG. 4 depicts components of a teaching and assessment system; and

FIG. 5 depicts a method of grading a test incorporating a math application.

### DETAILED DESCRIPTION

In accordance with the present disclosure there is provided a method for administering a test comprising: receiving at a server a test identifier in a request from a client; retrieving a test definition associated with the test identifier, the test definition providing a plurality of test questions including a test question associated with an identified math application and an associated grading algorithm for grading the associated question; retrieving the math application defining interactive components for presenting a concept or problem on the client; executing the math application at the server; receiving at the server updated state information of the math application from the client and an indication to grade the test question; grading the test question using the associated grading algorithm and the updated state information; and storing the graded test question.

In one or more embodiments, executing the math application at the server comprises: executing the math application at the server to generate an object model associated with the math application to store state information of the math application and to generate client-side code representing a view and one or more interactive controls of the math application; and providing the generated client-side code of the math application and client-side code for interacting with the test to the client.

In one or more embodiments, the method further comprises: executing the client-side code at a client computing device to display the math application and the one or more interactive controls of the math application; receiving one or more user interactions with the one or more interactive controls of the math application.

In one or more embodiments, the method further comprises: transmitting to the server updated state information of the math application.

In one or more embodiments, the method further comprises: updating the object model with the updated state information.

In one or more embodiments, the test definition further includes a question associated with a math application having a grading algorithm.

In one or more embodiments, the test definition further includes a question not associated with a math application.

In accordance with the present disclosure there is further provided system for administering a test using a server communicatively couplable to a plurality of client computing devices, the server comprising: a processing unit for executing instructions; a memory unit for storing instructions, which when executed by the processing unit configure the server to: receive a test identifier in a request from a client; retrieve a test definition associated with the test identifier, the test definition providing a plurality of test questions including a test question associated with an identified math application and an associated grading algorithm for grading the associated question; retrieve the math application defining interactive components for presenting a concept or problem on the client; execute the math application at the server; receive at the server updated state information of the math application from the client and an indication to grade the test question; grade the test question using the associated grading algorithm and the updated state information; and store the graded test question.

In accordance with the present disclosure there is provided executing the math application at the server comprises: executing the math application at the server to generate an object model associated with the math application to store state information of the math application and to generate client-side code representing a view and one or more interactive controls of the math application; and providing the generated client-side code of the math application and client-side code for interacting with the test to the client.

In accordance with the present disclosure there is provided at least one of the plurality of client computing devices comprises: a client processing unit for executing instructions; a client memory unit for storing instructions, which when executed by the client processing unit configure the client computing device to: execute the client-side code at a client computing device to display the math application and the one or more interactive controls of the math application; receive one or more user interactions with the one or more interactive controls of the math application.

In accordance with the present disclosure there is provided the instructions which when executed by the processing unit of the server further configure the server to:

transmit to the server updated state information of the math application.

In accordance with the present disclosure there is provided the instructions which when executed by the processing unit of the server further configure the server to:

update the object model at the server with the updated state information.

In accordance with the present disclosure there is provided the test definition further includes a question associated with a math application having a grading algorithm.

In accordance with the present disclosure there is provided the test definition further includes a question not associated with a math application.

Computer based teachings aides provide information to students to help understand a concept or problem. Teaching aides may allow students to interact with components in order to better understand the concept or problem. For example, in learning a math problem a student may interact with a plot of a function by changing the values of the function in order to better understand the effect of the variables. Frameworks exist that allow teachers to generate interactive teaching aides. The generated teaching aides may be math applications that execute within a framework environment. The framework environment may be provided at a server location in order to allow students to access the teaching aide from remote locations, such as from a computer located in the home. The generated math applications may be shared freely in order to make the teaching aides available to a wider audience.

Math applications may define interactive components for presenting a concept or problem on a remote client. A math application engine may execute the math application and display the components that allow a user to interact with the display.

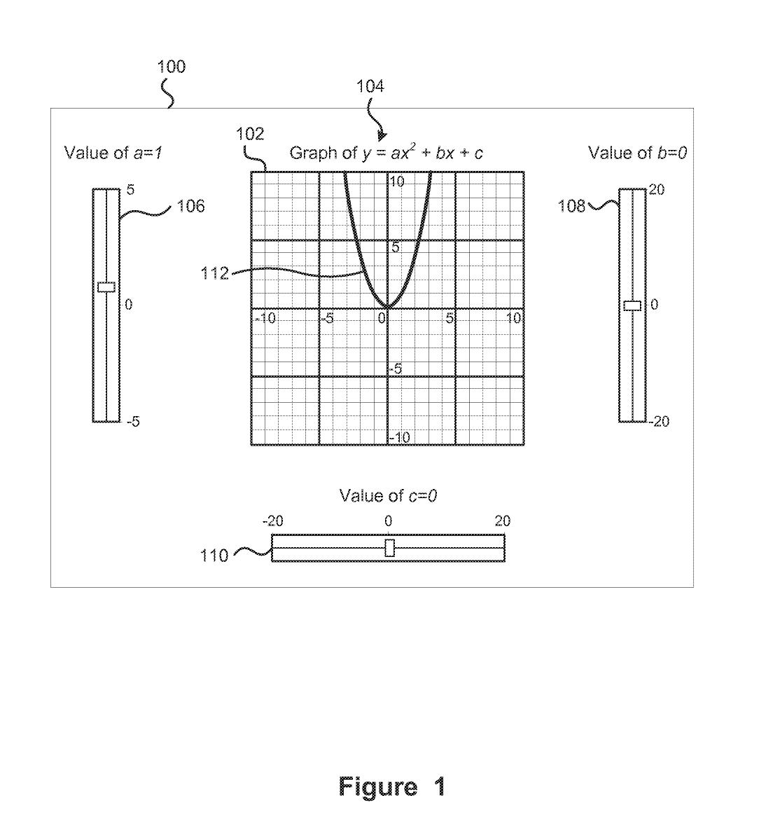

FIG. 1 depicts a display of a math application. Math applications may define interactive components for presenting a concept or problem on a remote client. A math application engine may execute the math application and display the components that allow a user to interact with the display. The math application may be provided by components executing on a server as well as components executing on a client of a user. The client may comprise a browser or math application viewer. The client provides a display 100 to the user of the math application. The display 200 may comprises various interactive components defined in the math application and provided by the math application engine. As depicted in FIG. 1, the display of the math application may comprise a graph or plot 102 of a function. The function that is plotted may be displayed 104 with the plot. As depicted, the plot 102 comprises a parabola 112 defined by the function y=ax²+bx+c. The display 100 further comprises sliders 106, 108, 110 that allow a user to change the values a,b,c of the plotted equation. When a user adjusts a slider value 106, 108, 110, the updated values may be provided from the client to the math application engine executing on a server, which updates the plot and returns the updated plot to the client for display.

The illustrative math application of FIG. 1 is a simple example for illustrating an interactive math application. Math applications may be generated for presenting numerous concepts or problems. For example, math applications may be generated to illustrate problems in various fields such as algebra, calculus, geometry, electronics, signal processing, physics. Further, although referred to as a math application, the concepts presented need not be related to mathematics in particular. For example, the interactive math application may present concepts or problems related to chemistry; however, regardless of the field of endeavor, the interactive application is referred to as a math application for consistency.

Further, although the display 100 of the math application depicts a plot area 102 as well as a number of user input sliders 106, 108, 110, it is possible to incorporate a number of different components into a math application including, for example, text boxes, picture boxes, buttons, labels, check boxes and radio buttons. Further, a math application does not need to display a graph. Rather, the interactive components may result in changes to displayed equations, text, pictures, colors or sizes of displayed components or other types of feedback.

The math application may define one or more variables or settings as well as input controls that allow a user to adjust the value of the variable or setting. The math application defines how the variables or settings are processed in order to provide an output as well as how the output should be presented to the user. The math application engine may execute a math application by processing the received input variables in accordance with the math application definition and provide the output to the client of the user. For example, the math application may define the output as a plot of the equation y=ax²+bx+c, as well as defining the input controls for adjusting the values o a,b,c as well as specifying the bounds of x,y. The math application engine may load the math application and present an initial state to the user. The user may adjust the input values, which are returned to the math application engine, for example through URL encoding, as a form submission or other communication means. The math application engine receives the updated values and determines the effect of the updated values on the output. In the example of FIG. 1, adjusting the values of a,b,c results in the math application engine re-plotting the equation and returning the plot to the client, for example as an image, for display.

In addition to providing teaching aides, such as math application, for presenting a concept or problem, computer based teaching systems may provide testing functionality. For example, a teacher may generate an online test to be taken by students. The test may comprise a number of questions for the student to answer. A testing engine may provide automated grading of the questions, provided the correct answers are defined when generating the test.

As described further below, the test engine and the math application engine may interact in order to allow a math application to be incorporated into a test question. In addition to allowing a question to incorporate the interactive components provided by the math applications, which may be generated and shared by numerous teachers, the question may define grading code that specifies how the question is to be marked based on the state of the math application. Accordingly, it is possible to generate automatically gradable test questions that incorporate pre-existing math applications even when the math application was not generated with grading functionality.

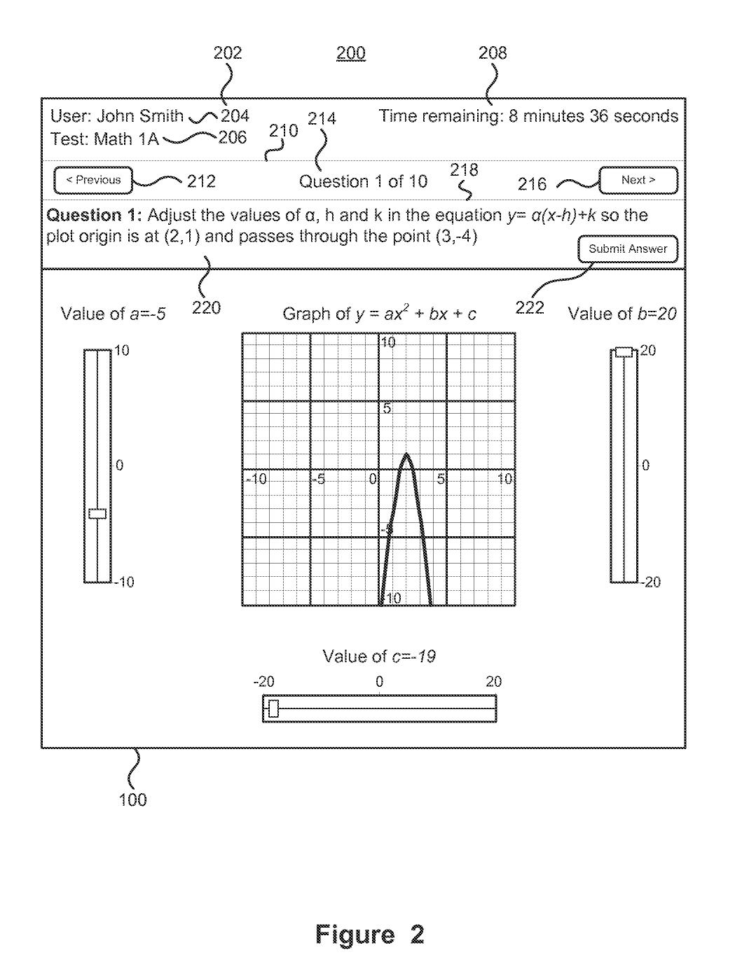

FIG. 2 depicts a display of a test question incorporating the math application of FIG. 1. The display 200 may be generated at a testing engine on a server as described further below. The display comprises the math application display 100, as well as additional information including for example test information 202 identifying a user taking the test 204, a name or identifier of the test 206 as well as an amount of time remaining for the test 208. The display 200 may further present the user with navigation information and controls 214 that allow the user to navigate through the test. For example, the navigation controls may include controls for moving to a previous question 212 and a next question 216. The navigation information may also provide information on the current question and the total number of questions in the test 214. The test display 200 may also display question information 218 that includes a question or instructions 220 as well as a control for submitting the answer for grading 222.

The math application may be displayed in an initial state, such as shown in FIG. 1. The user may interact with the displayed math application in accordance with the question or instructions 220. In the example of FIG. 2, this would include moving the sliders so that a==−5; b=20; c=−19. As the sliders are adjusted, the updated values may be provided to the math application engine in order to update the plot and return the updated plot for display. Once the student is satisfied with their response they may press the submit answer button 222 in order to submit the state of the math app to the testing engine for grading. Alternatively, the user may navigate to another question without submitting the answer. The state of the math application may be passed to the testing engine on the server in order to save the current state in order to allow a user to return to the question at a later time. It will be appreciated that the above interactions are only illustrative and other options are possible. For example, a user may only be able to proceed to the next question without returning to previous questions. Further, the answers may be automatically submitted to the testing engine for grading when the student proceeds to another question.

As described above, a math application may be executed at a server and allow a user to interact with displayed components in order to better understand or learn a concept, problem or idea. The math application engine on the server allows the math applications displayed on a client device to incorporate mathematical processing, or other types of processing for example related to chemistry or biology, without having to implement the possibly complex functions on the client device. Further, the math applications may be generated and shared among teachers. The testing engine allows the incorporation of math applications into test questions. Further, as described further below, the testing engine allows questions that incorporate math applications to be automatically graded, even if the math application was not originally generated taking into consideration grading.

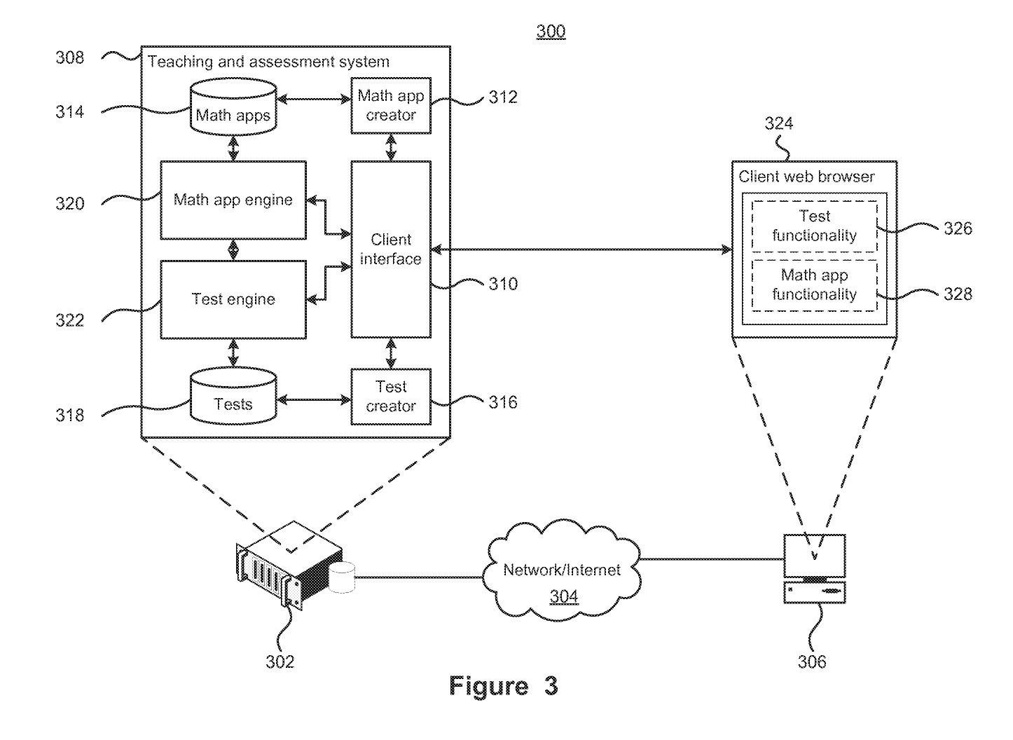

FIG. 3 depicts a teaching and assessment environment. As depicted, the environment 300 comprises a server computing device 302 in communication with a network 304 such as the internet. The server 302 may communicate with a client computing device 306. Although only a single server and a single client device are depicted, it is contemplated that the environment 300 may comprise additional servers and/or additional client computers.

The server 302 comprises one or more processing units for executing instructions that are stored in one or more memory units. When the instructions stored in the one or more memory units are executed by the one or more processing units, the server is configured to provide a teaching and assessment system 308. As described further, the teaching and assessment system 308 may interact with the client computing device 306 in order to generate math applications as well as to generate tests that may incorporate the math applications. Further, the teaching and assessment system 308 may also be used by the client 306 to access individual math applications, as well as access tests that may include questions that incorporate the math application.

The teaching and assessment system 308 may comprise a client interface 310 that interacts with clients. The client interface 310 may be for example, a web server that can receive and respond to HTML messages from the client. The teaching and assessment system 308 may include math application creation functionality 312 that generates an interface, which is provided to the client via the client interface, for use in generating math applications. The interface may allow a user to define an interactive math application. The math application creation functionality 312 may store the generated math applications in a database or other storage means 314. Further, it may be possible to generate math applications using other systems or programs.

The teaching and assessment system may further comprise a math application engine that provides a server-side framework for executing math applications. The math application engine 316 may be a component of the client interface. For example, the math application engine may run within an application container of a web server.

The teaching and assessment system 308 may further comprise test creation functionality 318. The test creation functionality 318 allows a user, such as a teacher, to generate tests. The test creation functionality 318 allows a user to specify test questions as well as answers. The test creation functionality 318 may also allow defining other test characteristics such as a length of time allowed for the test, layout options for displaying the test or questions, a test name or identifier, students of classes associated with the test as well as other characteristics. The test creation functionality may access the math applications store 314 in order to allow a test creator to select an existing math application for incorporating into a test question. The test creation functionality may also allow a user to define how the question should be graded. For example, in the case of a multiple choice question, the correct answer would be defined. More complex grading definitions are possible for various questions. For example, in the example test question of FIG. 2, the grading may provide ⅓ of a mark for setting the correct value for each slider. Further, the grading may define tolerances in the correct answer. The test creation functionality may store the generated test in a test database or store 320. Further, it is possible to store individual questions separately and incorporate them into tests. By storing questions individually, they may be easily incorporated into a number of different tests.

The teaching and assessment system 308 may further comprise a test engine 322 for administering and grading tests. The test engine 322 may retrieve tests from the test repository and generate an appropriate display for returning to the client. The test engine 322 may interact with the math application engine 316 in order to generate questions incorporating a math application. The test engine may receive responses from the client pertaining to answers to questions and may grade the questions as appropriate. The graded tests may be stored in a grades database or store, which may be accessed by teachers and/or students to view grades associated with one or more tests.

The server 302 may communicate with one or more client computing devices 306. Each computing device 306 may comprise a processing unit for executing instructions and a memory unit for storing the instructions, which when executed by the processing unit configure the computing device 306 to provide various functionality for interacting with the teaching and assessment system 308. The functionality may be provided within a web browser of the client computing device 306 as depicted. Additionally or alternatively, the functionality may be provided as separate applications running on the client computing devices 306 or in a execution container provided on the computing device. As depicted, the functionality may include test functionality 326 and math application functionality 328. The test functionality 326 may include functionality used to interact with the test creator functionality 316 on the server to generate tests. The test functionality may additionally or alternatively comprise functionality for taking one or more of the tests. If the test being created or taken includes a math application question, the functionality may further include the math application functionality 328 in order to allow the particular math application to be displayed. Additionally or alternatively, the math functionality 328 may comprises functionality for creating a math application.

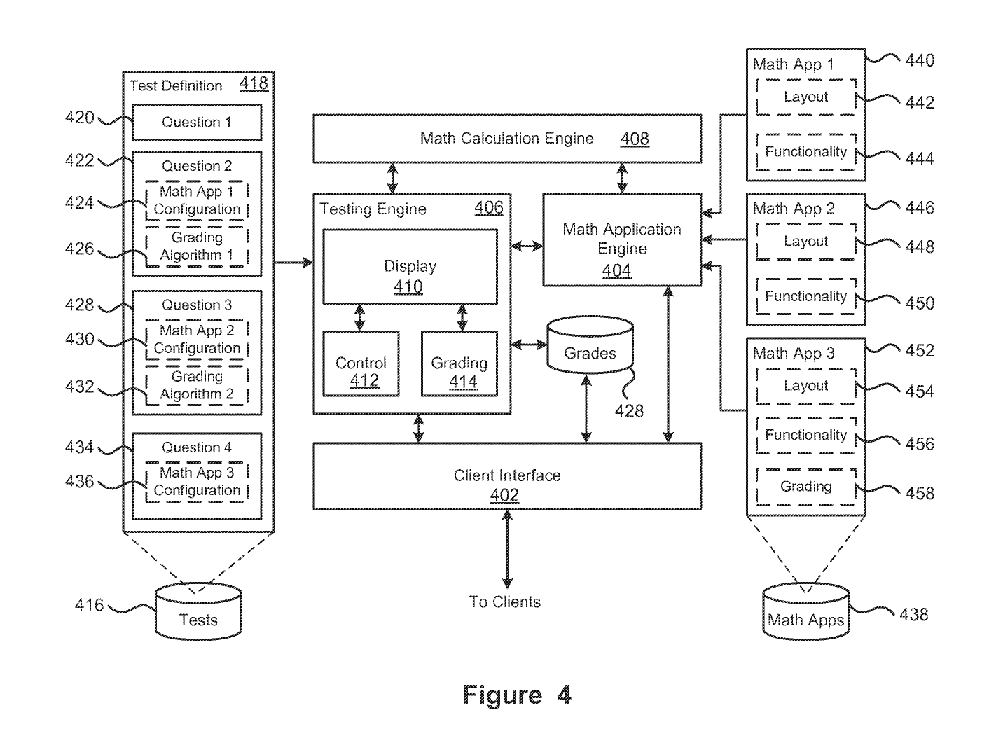

FIG. 4 depicts components of a teaching and assessment system. The teaching and assessment system 400 may provide the teaching and assessment system 308 described above with reference to FIG. 3. The teaching and assessment system 400 may include a client interface 402 that sends and receives data between the server system 400 and one or more client computing devices. The client interface 402 may be a web server that receives and services requests from clients. The client interface 402 interacts with a plurality of components in order to service a received request. As depicted the client interface 402 may interact with a testing engine 406 that provides functionality for administering a test to a plurality of students. The testing engine 406 may include functionality for generating a user interface to be displayed 410 on the client device. The testing engine 406 may further comprise control functionality that controls the overall operation of the testing engine and the administration of individual tests. The testing engine may further comprise grading functionality 414 for automatically grading the tests and storing the results in a grades database or store 428. The testing engine may interact with a math application engine 404 that provides math application functionality. One or more of the tests stored in the tests database 416 may comprise a math application question, which may require the testing engine 406 to interact with the math application engine 404, for example to receive math application results in order to grade a math application question.

As depicted, a test definition 418 stored in the tests database 416 may comprise a number of question definitions 420, 422, 428, 434, each of which defines a possible question in the test. Although not depicted the test definition may include additional information about the test such as, a name of the creator, subject matter area, a date created as well as other optional parameters. As depicted, the test definition may include different types of questions. For example question 1 420 may be a text based question such as a multiple choice or true or false type question. The question definition 420 may specify the type of the question, the question text, optional answer text as well as the correct answer test. The test engine 406 may process the question and generate an appropriate display for the question, along with test navigation functionality allowing navigation through the test. The question definition 420 may indicate which of the possible answers is correct and as such the answer may be graded by the grading functionality 414.

In addition to the text based question 420, the test definition 418 may also include questions that incorporate a math application. Questions 422, 428 and 434 each involve a math application. Each question definition 422, 428, 434 in addition to possible question text or instructions includes an indication of the particular math application to be used with the question and may include specific configuration information 424, 430, 436 for the particular math application in order to display the math application in a specific initial configuration. The test definition may incorporate math applications that were created without any thought of them being used as a question of a test, as well as math applications that were created in order to be incorporated into a test. Questions 422 and 428 are considered to be math applications that were created without any consideration as to their possible incorporation into a test. Question 434 is considered to be a math application that was created with the possibility of it being incorporated into a test. As depicted, each of the math applications 440, 446, 452 defined in the test definition 418 may be stored in one or more math application stores 438. Each math application provides a definition of the math application that can be used by the math application engine 404 when executing the math application to provide the desired functionality to the user. Each math application may comprise a layout definition 442, 448, 454 that describes the location of a plurality of user interface components such as, text labels, pictures, sliders, buttons graphs, input boxes etc. Each math application may further comprise math application functionality 444, 450, 456 that describes functionality provided by the defined layout definition. The math application functionality may be described in a mathematical scripting language. The scripting language may be processed by a math calculation engine 408 that may be utilized by both the math application engine 404 and the testing engine 406 to perform any calculations required, such as a grading formula for the grading functionality, or performing the functionality specified in a math application being executed by the math application engine.

For example, returning to the math application described with reference to FIG. 1, the layout definition may specify the location of the sliders, their possible values and their initial values. Additionally, the layout definition may specify a graph area and its parameters such as an initial scale for the x and y values as well as other plotting options. The functionality may indicate that if a value of one of the sliders is updated, the graph section should be updated to plot the new graph according to a particular equation such as that of a parabola.

Returning to FIG. 4, as depicted, both the math apps 440 and 446 do not include any grading functionality that would allow the testing engine to determine a grade for a question incorporating the math application. Accordingly, both question definitions 422. 428, which incorporate the math applications 440, 446 include a grading algorithm 426, 432. The grading algorithm specifies how a grade should be assigned based on parameters of the math application. The parameters of the math application may be retrieved through the math application engine 404. The question 434 incorporates a math application 452 that includes grading functionality 458 and as such, the question definition 436 does not include grading functionality. Instead, the testing engine 406 may utilize the grading functionality 458 of the math application 452 in order to determine a grade associated with the question.

The client interface 402 may allow a client to access the test engine functionality 406 by opening a test definition. A test definition 418, which may be referred to as a worksheet, includes one or more questions and may be accessed by a user via a URL, which opens the worksheet on the user's computing device 306. The URL may contain initialization parameters, for example in the form of a JSON string or URL encoding. During the opening phase an initialization routine in the test engine tests for the presence of a worksheet initialization routine in the given test worksheet. If the worksheet initialization routine is found it is invoked so that the worksheet can establish its initial conditions. The initialization parameters will be passed to the routine. If the worksheet initialization routine is absent, and as such no initialization routine is executed, then the system tests the JSON string, or URL encoding, for the presence of an item having a specific form that represents script code that is capable of performing a grading operation on the worksheet. The item may be a JSON item of the form “mw_grading_code”=“XXXXX” where XXXXX represents the script code that is capable of perform a grading operation. If the mw_grading_code component is present it is saved as the grading routine definition for the question. Alternatively, rather than passing the grading code to the testing engine via a JSON string, the grading code or script may be retrieved from the question definition.

The grading routine definition is a sequence of commands written in a script language as depicted in the following code listing.

//Get the values the student answered with
a := GetProperty(“Slider1”,”value”);
b := GetProperty(“Slider2”,”value”);
c := GetProperty(“Slider3”,”value”);
//set the initial grade to zero
grade := 0;
//add one third of a mark for getting the correct a
//value
if a = −5 then

grade := grade + 1/3;

end if;
//add one third of a mark for getting the correct b
//value
if b = 20 then

grade := grade + 1/3;

end if;
//add one third of a mark for getting the correct c
//value
if c = −19 then

grade := grade + 1/3;

end if;
//return the calculated grade
return grade;

Once a worksheet is loaded within an appropriate framework in a browser, the framework can request the content of the worksheet to be graded by causing a specifically formatted URL to be sent to the hosting teaching and assessment system server. The URL may contain a test worksheet identifier, a session identifier, a command identifier to indicate grading, an option that is passed to the grading routine and an optional checksum.

The worksheet identifier and session identifier are used to uniquely identify the specific instance of the question that is to be graded. There may be more than one instance of a question worksheet active in the system at any given time representing multiple attempts at a question by one or more users. The command identifier indicates to the system that the specific instance requires grading and the option allows the system to implement more than one method of grading. The checksum, if the system is configured to perform security checks, is a unique key that the system will use to validate the incoming grading URL. The checksum validation may be used to prevent spoofing or unauthorized access to the grading system.

Once the teaching and assessment system receives the URL it validates the checksum if used, the worksheet and session identifiers as well as the command identifier. The option may not validated at this level as it is passed through to the grading routines that are eventually executed by the math calculation engine 408. If any of the validation steps fail, the worksheet is not graded and an appropriate error is returned in response to the URL.

During client interaction with the worksheet, actions such as filling a value into a text box, or clicking a button will trigger events to be sent back to the server. The math application engine 404 on the server maintains a document object model (DOM), that captures the state of the client view for the math application associated with a question.

A successful validation of the URL has the testing engine 406 that is associated with the specific instance of the question worksheet perform the grading by calling a grading routine. The grading routine tests for the presence of a grading routine definition in the worksheet. If the grading routine is found to be defined, then it is invoked by the library routine and the option that was parsed from the incoming URL is passed as an argument to the grading routine. If the grading routine definition is not found in the worksheet then the grading routine definition that was defined from the mw_grading_code during initialization is invoked if it exists. If the mw_grading_code grading routine is not present then grading is not performed. Note that as previously mentioned, if the grading routine definition is external to the math-app, it may be set up at initialization time.

The grading routine evaluates the option argument and then grades the user derived content of the worksheet and determines the correctness of that content. Grading may be executed in the math calculation engine 408. Executing a GetProperty action in the grading script will cause the math calculation engine to send a stream call request to the math application engine that holds the client DOM view of the math application. The math application engine executing the math application will look into its DOM for the appropriate named component and return the requested property. The value of that property is returned back to the math calculation engine. For example, the grading routine retrieves the values of three sliders and uses these values in determining the grade for the question.

The result of evaluating the grading routine is returned to the grading functionality of the testing engine which in turn returns it to the server code that is handling the URL. The result that is returned can be of any textual format (e.g. numeric, alphanumeric, base64 encoded) If the grading routine fails due to some internal system error, as opposed to a wrong answer, the result should be prefixed with a tag “Error:” so that the system can distinguish between system problems and incorrect user responses. The received result may be stored in the grades database 428.

In addition to storing the grade, the grading functionality 414 may visually change the contents of the worksheet to indicate the correctness or incorrectness of the answer. For example, an incorrect item on the worksheet could be rendered in a red color or a correct result could be rendered in a green color.

Once the result is returned to the URL handler provided by the client interface, it is returned as a response to the URL that was sent from the client framework. An additional step that may be performed by the URL handler provided by the client interface is saving the state of the question at the time it was graded. This state may allow the system to restore the question to the graded state at a later time should the question and answer need to be reviewed. Also if the question contains a graph or plot the system produces a graphics image that graph or plot that can be saved along with the question state.

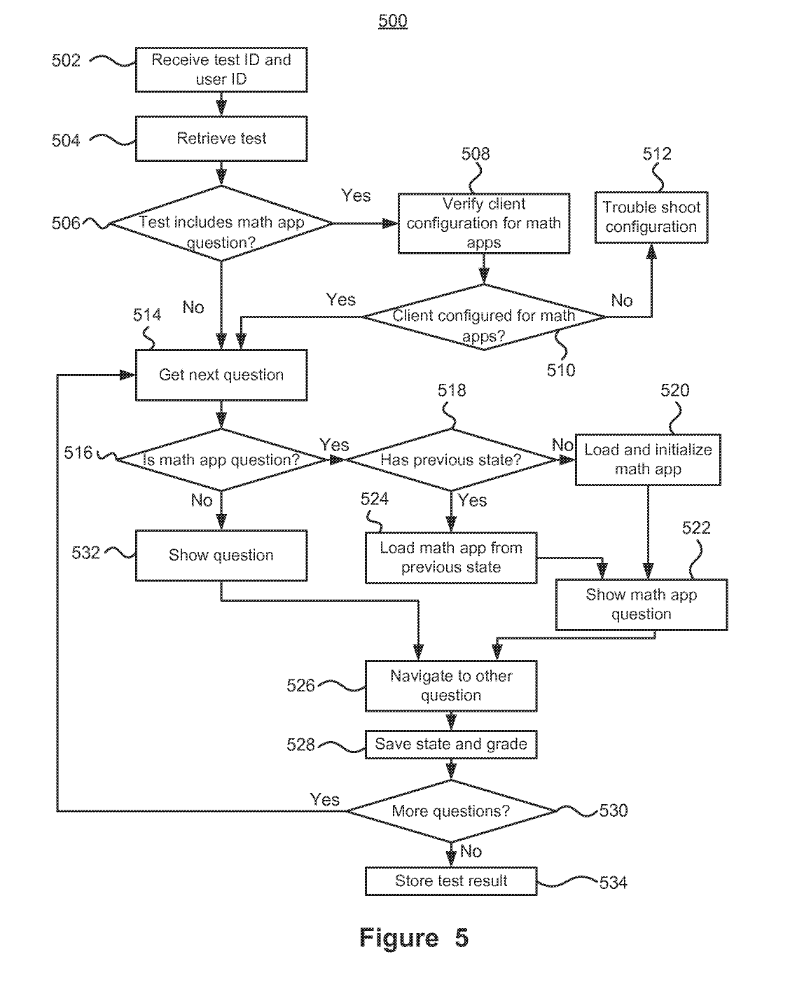

FIG. 5 depicts a method of grading a test incorporating a math application. The method 500 begins with receiving a test identifier (ID) and a user ID (502). The test ID indicates one of a plurality of tests to be administered to the user indicated by the user ID. The test indicated by the test ID is retrieved (504) and it is determined if the test includes a math application question (506). If the test does include a math application (Yes at 506) than the client configuration is verified to ensure that the math application can be displayed on the client device (508). It is determined if the client was configured correctly for the math application (510) and if it was not configured correctly (No at 510) then the configuration is trouble shot (512). If the client is correctly configured (Yes at 510), or the test doesn't include a math application question (No at 506), the next, or first, question of the test is retrieved (514). Once the test question is retrieved, it is determined if it is a math application (516) and if it is not a math application question (No at 516) the question is shown (532). The user may interact with the question, for example by providing or selecting an answer to the question and eventually navigate to another question (526). When the question is navigated away from, the state of the question may be saved and graded (528). Alternatively the state may be saved to be graded at a later time. It is determined if there are more questions (530) and if there are more questions (Yes at 530), the next question is retrieved (514) and it is determined if it is a math application question (516). If it is a math application question (Yes at 516), it is determined if the question has a previous state (518). If the math application question does not have a previous state associated with it (No at 518) then the math application is loaded and initialized (520) and the math application question can be shown (522). If the math application question is associated with a previous state (Yes at 518) the previous state is loaded (524) and the question is displayed (522). Again, another question can be navigated to (526) and the state of the question saved and graded (530). If there are no more questions in the test (No at 530), the test results can be stored (534).

The systems and methods described above allow a test to be generated that incorporates math application that may not have been created in order to be incorporated into a test. The questions incorporating these math applications can be graded automatically using a grading algorithm specified in the test or question definition. Further, the test may also incorporate math applications that are capable of grading an answer. For such questions, the test grades the question using the grading functionality provided by the math application.

Although the above discloses example methods, apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods and apparatus, persons having ordinary skills in the art will readily appreciate that the examples provided are not the only way to implement such method and apparatus. For example, the methods may be implemented in one or more pieces of computer hardware, including processors and microprocessors, Application Specific Integrated Circuits (ASICs) or other hardware components.

The present disclosure has described various systems and methods with regard to one or more embodiments. However, it will be apparent to persons skilled in the art that a number of variations and modifications can be made without departing from the teachings of the present disclosure.

What is claimed is:

1. A method for administering a test comprising:
receiving at a server a test identifier in a request from a client;
retrieving a test definition associated with the test identifier, the test definition providing a plurality of test questions including a test question associated with an identified math application and an associated grading algorithm for grading the associated question;
retrieving the math application defining interactive components for presenting a concept or problem on the client;
executing the math application at the server;
receiving at the server updated state information of the math application from the client and an indication to grade the test question;
grading the test question using the associated grading algorithm and the updated state information; and
storing the graded test question.

2. The method of claim 1, wherein executing the math application at the server comprises:
executing the math application at the server to generate an object model associated with the math application to store state information of the math application and to generate client-side code representing a view and one or more interactive controls of the math application; and
providing the generated client-side code of the math application and client-side code for interacting with the test to the client.

3. The method of claim 2, further comprising:
executing the client-side code at a client computing device to display the math application and the one or more interactive controls of the math application;
receiving one or more user interactions with the one or more interactive controls of the math application.

4. The method of claim 3, further comprising:
transmitting to the server updated state information of the math application.

5. The method of claim 2, further comprising:
updating the object model with the updated state information.

6. The method of claim 1, wherein the test definition further includes a question associated with a math application having a grading algorithm.

7. The method of claim 1, wherein the test definition further includes a question not associated with a math application.

8. A system for administering a test using a server communicatively couplable to a plurality of client computing devices, the server comprising:
a processing unit for executing instructions;
a memory unit for storing instructions, which when executed by the processing unit configure the server to:
receive a test identifier in a request from a client;
retrieve a test definition associated with the test identifier, the test definition providing a plurality of test questions including a test question associated with an identified math application and an associated grading algorithm for grading the associated question;
retrieve the math application defining interactive components for presenting a concept or problem on the client;
execute the math application at the server;
receive at the server updated state information of the math application from the client and an indication to grade the test question;
grade the test question using the associated grading algorithm and the updated state information; and
store the graded test question.

9. The system of claim 8, wherein executing the math application at the server comprises:
executing the math application at the server to generate an object model associated with the math application to store state information of the math application and to generate client-side code representing a view and one or more interactive controls of the math application; and
providing the generated client-side code of the math application and client-side code for interacting with the test to the client.

10. The system of claim 9, wherein at least one of the plurality of client computing devices comprises:
a client processing unit for executing instructions;
a client memory unit for storing instructions, which when executed by the client processing unit configure the client computing device to:
execute the client-side code at a client computing device to display the math application and the one or more interactive controls of the math application;
receive one or more user interactions with the one or more interactive controls of the math application.

11. The system of claim 10, wherein the instructions which when executed by the processing unit of the server further configure the server to:
transmit to the server updated state information of the math application.

12. The system of claim 9 wherein the instructions which when executed by the processing unit of the server further configure the server to:
update the object model at the server with the updated state information.

13. The system of claim 8, wherein the test definition further includes a question associated with a math application having a grading algorithm.

14. The system of claim 8, wherein the test definition further includes a question not associated with a math application.
